(19) United States
(12) Patent Application Publication
(10) Pub. No.: US 2017/0219171 A1
(43) Pub. Date: Aug. 3, 2017

(54) CONVERSION DEVICE

(71) Applicant: OSRAM GmbH, Munich (DE)

(72) Inventor: Joerg Sorg, Regensburg (DE)

(21) Appl. No.: 15/417,259

(22) Filed: Jan. 27, 2017

(30) Foreign Application Priority Data
Jan. 28, 2016 (DE) 10 2016 201 309.2

(51) Int. Cl. F21K 9/64

(52) U.S. Cl. CPC F21K 9/64; F21Y 2115/30

(57) ABSTRACT

In various embodiments, a conversion device is provided. The conversion device may include a phosphor element made of a phosphor element material for converting pump radiation into conversion radiation; and a scattering element embodied as a volume scatterer. The scattering element is arranged in direct optical contact with the phosphor element in order to be transilluminated by the conversion radiation. The phosphor element material is present in monocrystalline form in the phosphor element over a volume of at least 1×10⁻² mm³.

### CROSS-REFERENCE TO RELATED APPLICATION

This application claims priority to German Patent Application Serial No. 10 2016 201 309.2, which was filed Jan. 28, 2016, and is incorporated herein by reference in its entirety.

### TECHNICAL FIELD

Various embodiments relate generally to a conversion device including a phosphor element for converting pump radiation into conversion radiation.

### BACKGROUND

By way of example, a phosphor element of the aforementioned type may be used with a light-emitting diode (LED) to convert the e.g. blue primary light (the pump radiation) of the latter into e.g. yellow conversion light (the conversion radiation). The phosphor element emits the conversion radiation upon excitement with the pump radiation. In so doing, it is not necessary for the entire pump radiation to be converted in the phosphor element, but portions of non-converted pump radiation may also be used together with the conversion radiation as a mixture; i.e., in the aforementioned example, non-converted blue primary light and the yellow conversion light may, for example, result in white light when mixed.

Here, the phosphor element is typically constructed from phosphor particles with a conventional diameter of no more than 5 μm and may, for example, be produced by applying a suspension containing the phosphor particles therein and by evaporating away the liquid such that the agglomerated phosphor particles then remain, precisely on, for example, the emission surface of an LED.

### SUMMARY

In various embodiments, a conversion device is provided. The conversion device may include a phosphor element made of a phosphor element material for converting pump radiation into conversion radiation; and a scattering element embodied as a volume scatterer. The scattering element is arranged in direct optical contact with the phosphor element in order to be transilluminated by the conversion radiation. The phosphor element material is present in monocrystalline form in the phosphor element over a volume of at least 1×10⁻² mm³.

### BRIEF DESCRIPTION OF THE DRAWINGS

Below, the invention will be explained in more detail on the basis of exemplary embodiments, wherein the individual features within the scope of the coordinate claims may also be essential to the invention in other combinations and also wherein there continues to be no distinction in detail between the claim categories.

FIG. 1 shows a first conversion device according to various embodiments in a schematic illustration;

FIG. 2 shows a second conversion device according to various embodiments as an alternative to the embodiment in accordance with FIG. 1;

FIG. 3 shows a comparison of the internal quantum efficiencies for a powdery YAG:Cer phosphor and a monocrystalline YAG:Cer phosphor;

FIG. 4 shows an illumination apparatus including an LED as pump radiation source and a conversion device in accordance with FIG. 1;

FIG. 5 shows a first illumination apparatus including a laser as pump radiation source and, arranged at a distance therefrom, a conversion device in accordance with FIG. 1; and

FIG. 6 shows a second illumination apparatus including a laser arranged at a distance from the conversion device, wherein operation is carried out in a reflection mode in contrast to the structure in accordance with FIG. 5.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

Various embodiments specify a particularly advantageous conversion device.

According to the various embodiments, a conversion device is provided including a phosphor element made of a phosphor element material for converting pump radiation into conversion radiation and a scattering element embodied as a volume scatterer, wherein the scattering element is arranged in direct optical contact with the phosphor element in order to be transilluminated by the conversion radiation, and wherein the phosphor element material is present in monocrystalline form in the phosphor element over a volume of at least 1×10⁻² mm³ (also referred to as “macroscopically monocrystalline” below), e.g. present in monocrystalline form in the entire phosphor element, and by a conversion device (incidentally with the same structure) in which the phosphor element is not “macroscopically monocrystalline” but includes a multiplicity of comparatively large partial volumes, each with a volume of at least 5×10⁻⁶ mm³, throughout which the phosphor element material, in its own right, is present in monocrystalline form in each case, i.e. respectively present in monocrystalline form in each partial volume (also referred to as “sub-macroscopically monocrystalline”).

Various embodiments are found in the dependent claims and in the entire disclosure, the illustration not always distinguishing in detail between apparatus aspects and method aspects or use aspects; in any case, the disclosure should implicitly be read in respect of all claim categories.

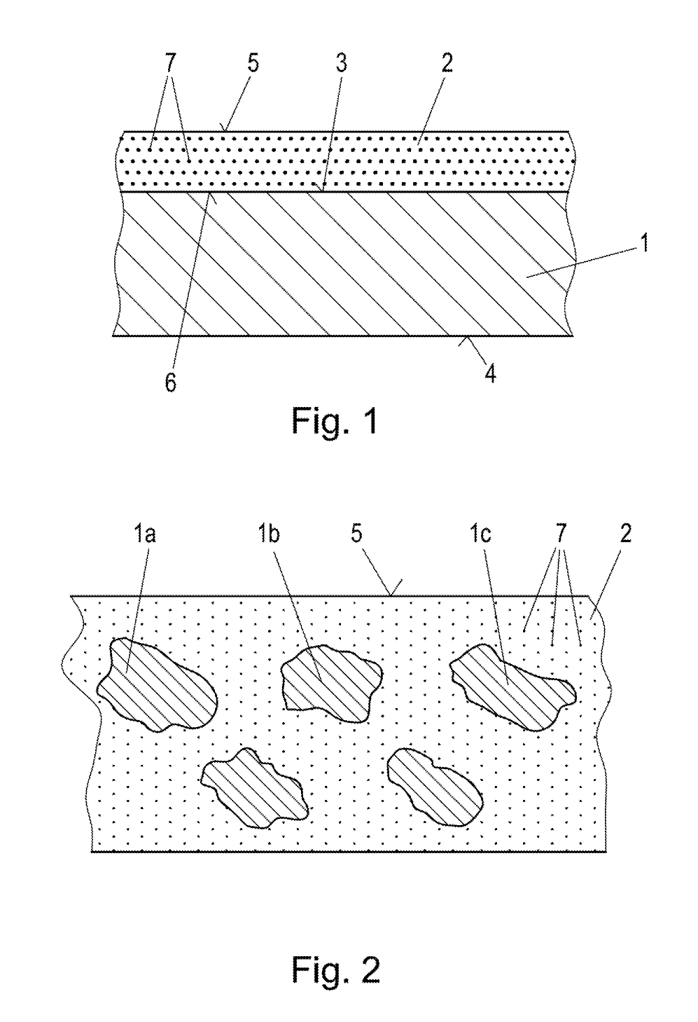

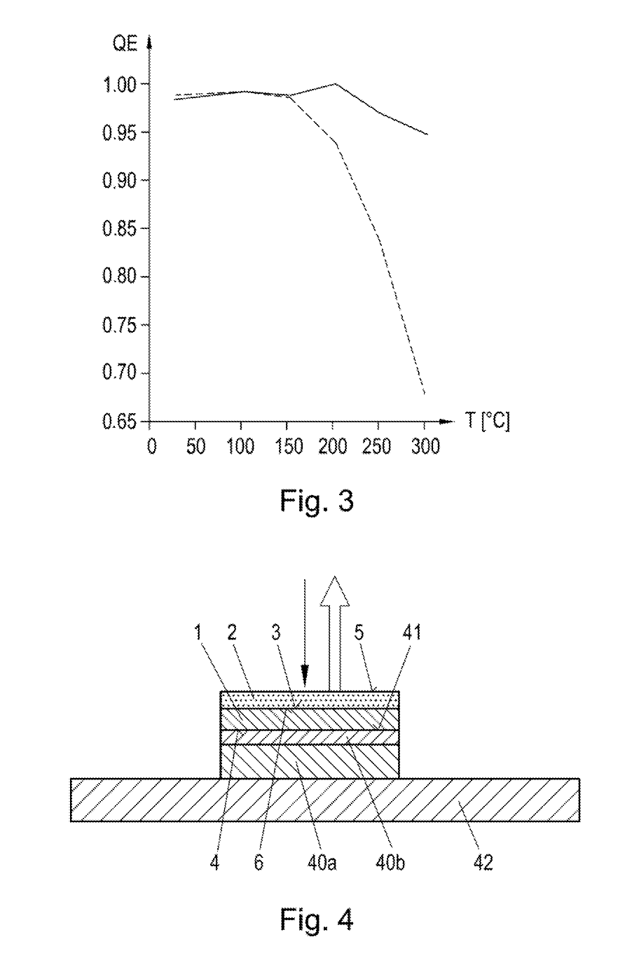

Thus, various embodiments may be realized in two ways, namely by combining a scattering element with either a macroscopically monocrystalline phosphor element (cf. FIG. 1 for illustrative purposes) or, precisely, with a sub-macroscopically monocrystalline phosphor element (cf. FIG. 2 for illustrative purposes). In the latter case, the monocrystalline property is distributed among a plurality of partial volumes but these are sufficiently large in each case so that the monocrystalline property comes to the fore in the conversion properties. In various embodiments, this relates to the quantum efficiency which, specifically in the case of a single crystal, only drops off slightly in the case of elevated temperatures, for example above 150° C., whereas it drops off strongly in the case of the same phosphor in polycrystalline form/particle form; cf. FIG. 3 for illustrative purposes. Consequently, the structure according to various embodiments allows the operating temperature of the phosphor element to be increased without substantial losses in the conversion efficiency.

However, the inventor determined that a single crystal may be disadvantageous in respect of output coupling of the conversion radiation generated therein; in simple terms, it is possible that although more conversion radiation is generated (at an elevated temperature), the output coupling of the latter deteriorates. Therefore, according to various embodiments, the (macroscopically or sub-macroscopically) monocrystalline phosphor element is provided in direct optical contact with the scattering element embodied as a volume scatterer and the scattering element material and the phosphor element material are matched to one another in terms of the refractive indices thereof. Consequently, the losses occurring at the interface(s) when the conversion radiation passes from the phosphor element into the scattering element which differs from the latter are lower than they would be, for example, in the case of a direct transition from the phosphor element into air.

Back reflections do also occur during the transition from the scattering element into the air (on account of the total-internal reflection or else Fresnel losses), i.e. during output coupling from the scattering element. However, in the process, the configuration thereof as a volume scatterer comes to the fore because, at the included scattering centers, conversion radiation propagating to the side under an angle which is actually too flat for emergence at the emergence surface may, in portions, be scattered forward, at a steeper angle, to the emergence surface. Furthermore, conversion radiation initially not outcoupled but, instead, reflected back may also be scattered and hence may be guided anew in the direction of the emergence surface with a statistical distribution. As it were, the conversion radiation guided anew to the emergence surface by means of the scattering receives a “second chance”; the portion of conversion radiation outcoupled overall may be increased.

In summary, the single-crystal phosphor element may on the one hand improve the temperature characteristic, i.e. generate more conversion radiation at an elevated temperature; on the other hand, the scattering element then in fact renders said conversion radiation usable, i.e. an increased efficiency emerges overall. By way of example, the improved temperature characteristic may facilitate more compact structures and/or structures in which the conversion device need not be cooled separately by way of a cooling body, which may offer cost advantages. Since higher energy densities may also be realized in the conversion device, more, or more concentrated, pump radiation may be radiated thereon; this ultimately then allows e.g. a higher luminance to be achieved.

In the case of the macroscopically monocrystalline phosphor element, the volume throughout which the phosphor element material is present in monocrystalline form is at least 1×10⁻² mm³, 2.5×10⁻² mm³, 5×10⁻² mm³, 7.5×10⁻² mm³, 1×10⁻¹ mm³, 2.5×10⁻¹ mm³ or 5×10⁻¹ mm³, with this sequence indicating increasing preference; possible upper limits may (independently thereof) lie at e.g. at most 100 mm³, 50 mm³, 10 mm³ or 5 mm³ (within the scope of this disclosure, “1 mm³” generally corresponds to “1×10⁻⁹ m³”).

In the case of the sub-macroscopically monocrystalline phosphor element, the partial volumes each have a volume of at least 5×10⁻⁶ mm³, 7.5×10⁻⁶ mm³, 1×10⁻⁵ mm³, 2.5×10⁻¹ mm³, 5×10⁻⁵ mm³, 7.5×10⁻² mm³ or 1×10⁻⁴ mm³, with this sequence indicating increasing preference; possible upper limits may (independently thereof) lie at e.g. at most 1×10⁻² mm³, 5×10⁻³ mm³ or 1×10⁻³ mm³. By way of example, the “multiplicity” of partial volumes may be read to be at least 100, 1000, 5000 or 10 000 partial volumes, wherein (independently thereof) possible upper limits may lie at e.g. at most 1×10⁸, 1×10⁷ or 1×10⁶ (the sequence in each case indicating increasing preference). It is not mandatory for all partial volumes of the sub-macroscopically monocrystalline phosphor element to have the minimum dimension according to the main claim; instead, there may also be smaller partial volumes in addition to the partial volumes according to the main claim; however, by way of example, all monocrystalline partial volumes in their own right have a corresponding minimum dimension.

For the purposes of the described optical coupling, the scattering element material and the phosphor element material are matched in terms of the refractive indices thereof; this is because, in an exemplary configuration, the refractive index of the scattering element material should deviate in terms of magnitude by at most 20%, at most 15%, 10% or 5%, said sequence indicating increasing preference, from the refractive index of the phosphor element material (the difference relates to the latter). Even though matching which is as accurate as possible may be preferred, possible lower boundaries may, for example, lie at 1% or 3%. Refractive indices at a wavelength of 589 nm are considered. In various embodiments, the refractive index of the scattering element material is less than that of the phosphor element material, which may further assist the output coupling.

Arranging scattering element and phosphor element in “direct optical contact” means that, at best, an intermediate material is provided therebetween, said intermediate material having a refractive index which deviates from at least one of the refractive indices of the scattering element material and the phosphor element material by no more than 20%, no more than 15%, 10% or 5%, said sequence indicating increasing preference (possible lower boundaries may, for example, lie at 1% to 3%). By way of example, the intermediate material may form an adhesive layer, by means of which scattering element and phosphor element are interconnected.

Using an appropriate intermediate material allows the losses during a transition from the phosphor element into the scattering element to be kept low; preferably, the refractive index of the intermediate material is less than that of the phosphor element material and more than that of the scattering element material. Thus, “in direct optical contact” means, at best, with an appropriate intermediate material therebetween, but e.g. directly adjoining one another. The radiation does not pass through an optically effective air volume between scattering element and phosphor element.

In general, the conversion may be a down conversion; i.e., the pump radiation is converted into conversion radiation with a longer wavelength. The conversion radiation, which may also be referred to as conversion light, has at least portions in the visible spectral range (380 nm to 780 nm); a large majority of the radiation power thereof, for example at least 60%, 70%, 80% or 90%, e.g. the entire conversion radiation, may lie in the visible spectral range. By way of example, the pump radiation may also be UV radiation; however, blue light, which then—e.g. with only partial conversion—may be used in part in a mix (which may be promoted by the scattering element) with the conversion radiation, may be provided.

The configuration as “volume scatterer” means that scattering centers are arranged within the scattering element in a manner distributed over the volume thereof. Scattering at the scattering centers is preferably carried out passively, i.e. without a change in the wavelength. Thus, for example, scattering particles, for example titanium dioxide particles, may be embedded in a matrix material, e.g. glass. In this case, the totality of matrix and scattering particles constitutes the scattering element (material); however, the latter may also have a homogeneous structure, for example in the case of a ceramic scattering element made of aluminum oxide or magnesium oxide. In general, the configuration as a volume scatterer may naturally also be combined with a scattering surface structure, for example a roughened surface; however, the scattering element may only be embodied as a volume scatterer, i.e., the surface thereof does not have separate structuring.

For example in respect of the further configuration of the sub-macroscopically monocrystalline phosphor element, there are different options which are discussed in detail below and briefly discussed in advance for an improved understanding. This is because, firstly, the partial volumes may each be formed by a separate phosphor body, with the phosphor bodies then being embedded in a matrix and thus being kept together. Then, the phosphor element material is present in an interrupted, i.e. non-continuous, manner over the phosphor element. By way of example, a glass ceramic may form the matrix, wherein the single crystals (e.g. YAG, see below) are precipitated in a targeted manner from the glass ceramic melt for production purposes and the residual glass ceramic melt then forms the matrix.

In general, however, the phosphor element material may also be provided in a continuous, in its own right contiguous, manner in the sub-macroscopically monocrystalline phosphor element (it is continuous in the macroscopically monocrystalline phosphor element). Thus, in that case, the partial volumes in which the phosphor element material is respectively always monocrystalline in its own right may also be directly adjoining one another in the phosphor element; i.e., the latter may be subdivided into comparatively large grains.

In various embodiments which relates to both a macroscopically and a sub-macroscopically monocrystalline, but in any case contiguous phosphor element, the latter forms a contiguous emission surface on which the scattering element is arranged. The emission surface may have an area of at least 0.25 mm², 0.5 mm², 0.75 mm² or 1 mm², wherein possible upper limits (independently thereof) may lie at e.g. at most 100 mm², 50 mm² or 25 mm² (the sequence in each case indicating increasing preference). Even if the scattering element is also able to completely enclose, i.e. encapsulate, the phosphor element in general, a side surface of the phosphor element opposite the emission surface may be free from scattering elements. In various embodiments, the scattering element is only arranged on the emission surface.

In general, the phosphor element may be operated both in reflection and in transmission, i.e. the (pump radiation) incoming radiation surface and the (conversion radiation) emission surface may coincide (reflection) or lie opposite one another (transmission). Even if the conversion radiation is generally emitted in an omnidirectional manner, i.e. no direction is emphasized yet in this respect, what surface satisfies what function ultimately emerges from the overall structure. Thus, in the embodiment specified in the paragraph above, the scattering element may, for example, already set the emission surface because the conversion radiation is precisely outcoupled therefrom.

In the case of an irradiation apparatus (illumination apparatus) with a pump radiation source, the relative arrangement thereof in relation to the phosphor element or the pump radiation guide thereto sets the incoming radiation surface; depending on the structure, an optical unit may, for example, also be provided at the emission surface (downstream of the scattering element) in order to lead the conversion radiation away as efficiently as possible. In general, a mirror which is reflective for at least the conversion radiation may be arranged at the side surface of the phosphor element lying opposite to the emission surface, which mirror may have a dichroic embodiment (transmissive for the pump radiation) in the case of a transmission operation and may be a full mirror in the case of a reflection operation.

In a configuration, the scattering element is fastened to the emission surface by way of a joining connection layer (cf., additionally, the explanations above in relation to the “intermediate material” as well). Hence, the scattering element and the phosphor element are in each case produced separately in their own right and then connected to one another by joining. The joining connection layer may be provided such that it is made of e.g. silicone, siloxane or silazane, or else made of a sol-gel material on the basis of aluminum oxide and/or silicon dioxide as well, and, further, glass may also form the joining connection layer.

In various embodiments, the scattering element material is a ceramic material (which may also generally be provided, see below for more details) and the scattering element is sintered onto the phosphor element. By way of example, this may be carried out by solid state sintering without flux at a high temperature or by liquid phase sintering with flux, e.g. glass. The scattering element may at first be produced in its own right and then sintered on; however, in general, it may also only be formed (created) by the sintering process itself.

In various embodiments, the scattering element is applied to the emission surface as a coating. Here, it is possible, for example, for scattering particles, for example titanium dioxide particles, to be applied in a manner embedded in a matrix material. All materials mentioned above for the joining connection layer between phosphor element and scattering element may be considered for the matrix material (silicone, siloxane, silazane, the sol-gel material and, finally, glass as well). However, the scattering element may also be applied as a thin-film coating; in general, for example, it may also be applied in a bath, but may be precipitated from the gaseous phase. An application by sputtering may be provided; i.e., for example, a sputtered aluminum oxide layer may form the scattering element, the scattering properties of which in detail may then still be adjusted in a tempering step following the application.

In various embodiments, which may relate to the scattering element fastened by way of a joining connection layer, the sintered-on scattering element or the scattering element applied as a coating, the conversion device includes a plurality of phosphor elements, respectively in a layered form in their own right, and a plurality of scattering elements, respectively in a layered form in their own right, said phosphor elements and scattering elements being arranged in a layer stack. In a stacking direction perpendicular to the layer directions (in which the layers thus have their planes of extent), in which the layers are placed in succession, phosphor element layer and scattering element layer then always follow one another in alternating fashion. Thus, a scattering element layer follows each phosphor element layer in the stacking direction and vice versa (this does not apply to the last layer of the stack). By way of example, for production purposes, the layers may initially be produced respectively in their own right and then be placed against one another, either with a joining connection layer therebetween in each case or, in the case of sintering, also directly on one another.

Finally, various embodiments relates to the phosphor element constructed from separate phosphor bodies, with these phosphor bodies being embedded in a matrix material (cf. the initial summary at the outset). In various embodiments, the scattering element material forms the matrix, i.e. the phosphor bodies are embedded into the scattering element. The “separate” phosphor bodies are not contiguous in their own right, i.e. over the phosphor element material, but in each case constitute closed volumes of the phosphor element material in their own right. Then, they are held together by way of the matrix.

In various embodiments, the scattering element material is a ceramic material. Then, the conversion device may be produced, for example, by joining large single crystals of the phosphor element material (which form the partial volumes) with the ceramic scattering element/matrix material in a sintering process. Secondly, the comparatively large YAG single crystals may however also be produced in a matrix proceeding from a two-phase ceramic by grain growth at an elevated temperature and/or under high pressure.

The configurations illustrated below may now be of interest both for a sub-macroscopically monocrystalline phosphor element and for a macroscopically monocrystalline phosphor element.

In a configuration, the phosphor element material is cerium-doped yttrium aluminum garnet (YAG:Cer). In the case of the “coating as scattering element” and “sintered-on scattering element” variants, this may be in a single phase form; by contrast, it may be present in a multiphase form, e.g. in a two-phase form with the ceramic matrix/scattering element material as second phase in the “separate phosphor bodies in matrix” variant mentioned last.

In a configuration, the scattering element material is a ceramic material, e.g. aluminum oxide or magnesium oxide; the ceramic material may then form either a matrix for the phosphor bodies or an element attached/sintered onto the phosphor element. By way of example, a ceramic scattering element material may be provided on account of the good thermal properties, e.g. on account of the good thermal conductivity.

In a configuration, the scattering element material and the phosphor element material directly adjoin one another, for example in the case of the sintered-on scattering element or the phosphor bodies sintered into the scattering element material, or else in the case of the scattering element applied as a coating onto the phosphor element. In addition to optical effects (no intermediate material and hence one interface less), such a direct connection may, for example, also be of interest for thermal reasons or in respect of a robust structure over the service life thereof.

In a development of the conversion device, the lateral surface thereof, at least in portions, is embedded in a material with a high reflectivity. The term lateral surface should be understood in this context to mean that the emission surface and the surface opposite thereto on the surface of the conversion device are left out. As a result, the lateral light propagation is reduced and hence the luminance in the emission direction is increased. Moreover, this improves the light mixing.

Various embodiments also relate to an irradiation apparatus, e.g. an illumination apparatus, in which a conversion device disclosed in the present case is combined with a pump radiation source for emitting the pump radiation. Here, the two components are arranged relative to one another in such a way that some of the emitted pump radiation is incident on the phosphor element in any case during operation. For reasons of efficiency, it may be provided for all of the pump radiation to be incident on the phosphor element; however, for reasons of arrangement, there may also be upper limits of e.g. 99%, 97% or 95%; for example, at least 60%, 70% or 80% of the pump radiation emitted by the pump radiation source is incident on the phosphor element (the percent specifications are based on the radiation power).

In various embodiments, a light-emitting diode (LED), generally also on an organic basis (OLED) but e.g. on an inorganic basis, is provided as pump radiation source. Then, the phosphor element and, accordingly, the scattering element as well are e.g. provided in direct optical contact with an emission surface of the LED (cf., the disclosure above in relation to “direct optical contact”, i.e. in respect of “intermediate material”, etc.). By way of example, the conversion device may therefore be fastened to the emission surface by way of a joining connection layer; by way of example, the conversion device may also be part of a housing of the LED (in the present case, “LED” refers to the LED chip), i.e. enclose the latter, for example together with a filler material (e.g. compression molding composition or silicone) and/or an assembly body (leadframe).

The combination with a conversion device according to various embodiments may, for example, be provided to the extent that this may allow an increase in the operating temperature of the LED (it is generally the properties of the phosphor element which are limiting; the remaining component parts may usually also be operated at higher temperatures). In the case of a thermal connection which is unmodified compared to the prior art, the LED may then, for example, be operated at a higher current density, as a result of which the light yield may be improved. In a complementary or alternative fashion, it is also possible, for example, to simplify the cooling concept; i.e., it is, for example, possible to realize a structure without a separate cooling body.

In various embodiments, a laser, e.g. a semiconductor laser, is provided as pump radiation source and the phosphor element is arranged at a distance therefrom. Upstream of the phosphor element, the pump radiation then passes through a gas volume, e.g. air, in an optically effective manner. “Optically effective” means that there are refractions at the gas volume/phosphor element transition in this case. An optical unit, for example a lens which collimates the pump radiation (collimation lens) and/or a lens which focuses the pump radiation onto the incoming radiation surface of the phosphor element, may be provided between laser and phosphor element. Here, “lens” can be read to mean both a single lens and a system of a plurality of single lenses. Light sources with a high luminance may be realized using the combination of laser source and phosphor element arranged at a distance therefrom; more pump radiation may be introduced into the phosphor element, which may assist in increasing the luminance or the luminous flux overall, as a result of increasing the operating temperature which is facilitated by the conversion device according to various embodiments (see above).

Various embodiments also relate to a method for producing a conversion device or irradiation apparatus as disclosed in the present case, wherein scattering element and phosphor element are provided in direct optical contact with one another, which may be effected by sintering or coating, but also by way of e.g. adhesive bonding to one another. Reference is explicitly made to the disclosure above and the specifications in relation to a method contained therein.

Exemplary fields of application of the irradiation apparatus or of a corresponding phosphor element may, for example, lie in the motor vehicle illumination industry, e.g. for external illumination of motor vehicles, for example for illuminating the street using a front headlamp, for example also in a variable manner, i.e., for example, masked in a manner depending on the oncoming traffic. Further fields of application may lie in the effect illumination industry; secondly, the irradiation apparatus may, however, also serve for operating field illumination. The irradiation apparatus may further be used as a light source for a projection appliance (for data/film projection), endoscope or else stage spotlight, for example for illuminating the scene in the film, television or theater industry. In general, use in industrial surroundings is also possible, and also in the field of building or architecture illumination, e.g. external illumination.

FIG. 1 shows a conversion device according to various embodiments, namely a phosphor element 1 made of monocrystalline yttrium aluminum garnet (YAG:Ce) in the entirety thereof. A scattering element 2 made of aluminum oxide is arranged with direct optical contact on this YAG:Ce single crystal. By way of example, the former may be applied by sputtering or sintered-on as a coating. In any case, the scattering element 2 is applied to an emission surface 3 of the phosphor element 1, said emission surface lying opposite an incoming radiation surface 4.

Thus, in FIG. 1, the pump radiation influx is from below and the pump radiation, which is blue pump light in the present case, then is converted into yellow conversion light in the phosphor element 1. Here, not all of the pump light is converted; instead, a non-converted part thereof emerges together with the conversion light at the emission surface 3 and hence enters into the scattering element 2. In the process, it is possible to keep losses at the interface comparatively low by virtue of phosphor element material and scattering element material being matched to one another in terms of the refractive indices thereof.

Then, if there are back reflections, e.g. total-internal reflections or so-called Fresnel losses, during the emergence at an emergence surface 5 of the scattering element 2 (which lies opposite the entrance surface 6), the light reflected back is incident on scattering centers 7 distributed through the volume of the scattering element 2. The light originally reflected back at the emergence surface 5 is then scattered back at said scattering centers with certain probability, i.e. once again guided in the direction of the emergence surface 5. Spoken illustratively, some of the light not outcoupled initially at the emergence surface 5 thus obtains a “second chance” in any case, as a result of which, overall, it is possible to outcouple more light.

FIG. 2 shows an alternative conversion device, in which the phosphor element 1 is subdivided into a multiplicity of phosphor bodies 1a, b, c, in which the YAG:Ce, in any case, is present in monocrystalline form in its own right. These phosphor bodies 1a, b, c are embedded into the scattering element 2; in this respect, the scattering element material (once again aluminum oxide) forms a matrix. However, the scattering element 2 could also, for example, be provided such that it is made of glass with scattering particles, for example titanium dioxide particles, (which incidentally also applies to the embodiment in accordance with FIG. 1), wherein the phosphor bodies 1a, b, c then would be embedded in the glass together with the scattering particles.

In terms of functionality, a comparable interaction as explained with reference to FIG. 1 emerges for the respective phosphor bodies 1a, b, c which are monocrystalline in their own right and provided in direct optical contact with the scattering element 2; light (conversion light with a portion of non-converted pump light) reflected back at the emergence surface 5 of the scattering element 2 is, in part, guided anew to the emergence surface 5 by way of the scattering.

Even if the phosphor bodies 1a, b, c are not contiguous, they each have a certain minimum dimension (≧1×10⁻⁴ mm³) in their own right, which is why the conversion properties are dominated by the volume properties and surface effects are sidelined, like in the case of the overall monocrystalline phosphor element 1 in accordance with FIG. 1.

FIG. 3 illustrates the effect which may emerge in the case of monocrystalline YAG:Ce in comparison with conventional YAG:Ce. To this end, the internal quantum efficiency (QE) is plotted as a dimensionless variable against the operating temperature of the YAG:Ce in monocrystalline form (full line) or in conventional powdery form (dashed line). What is shown here is that the quantum efficiency of the powdery YAG:Ce drops significantly at elevated temperatures above 150° C. in this case, whereas it does show a small change in the case of the monocrystalline form but, overall, remains comparatively high. In conclusion, YAG:Ce in monocrystalline form may be operated at higher operating temperatures than in the conventional powdery form, without this noticeably reducing the quantum yield.

As a result of the combination according to various embodiments with a scattering element 2 (cf. FIG. 1 and FIG. 2), the increased quantity of light generated at the elevated operating temperature may ultimately also be actually used more. This is because the scattering element 2 optimizes the output coupling from the monocrystalline phosphor element 1 (which is therefore also efficient at high temperatures).

FIG. 4 now shows a conversion device according to various embodiments including the phosphor element 1 and scattering element 2 in conjunction with an LED 40. In the schematic illustration, the latter is subdivided into substrate 40a and epitaxial layer 40b, in which the light is generated. The phosphor element 1 of the conversion device has been placed in direct optical contact with the LED 40 at the emission surface 41 of the latter, namely connected therewith by way of a joining connection layer (not depicted here).

The LED 40 is assembled on a cooling body 42; further details of the assembly, such as e.g. the electrical contacting of the LED 40, are not depicted for reasons of clarity. During operation, the LED 40 emits blue light at the emission surface 41, said blue light passing through the phosphor element 1 as pump radiation and, in the process, being converted in part to form yellow conversion light (see above). Finally, white mixed light is output at the emergence surface 5 of the scattering element 2.

In contrast to a comparable structure with a powdery phosphor, the operating temperature may be increased using the conversion device according to various embodiments, with the scattering element 2 equally ensuring efficient output coupling. On account of the higher possible operating temperature, it is possible, for example, for the cooling body 42 to be smaller than in a comparative case and/or for the LED 40 to be operated at a higher current, which helps optimize the light yield.

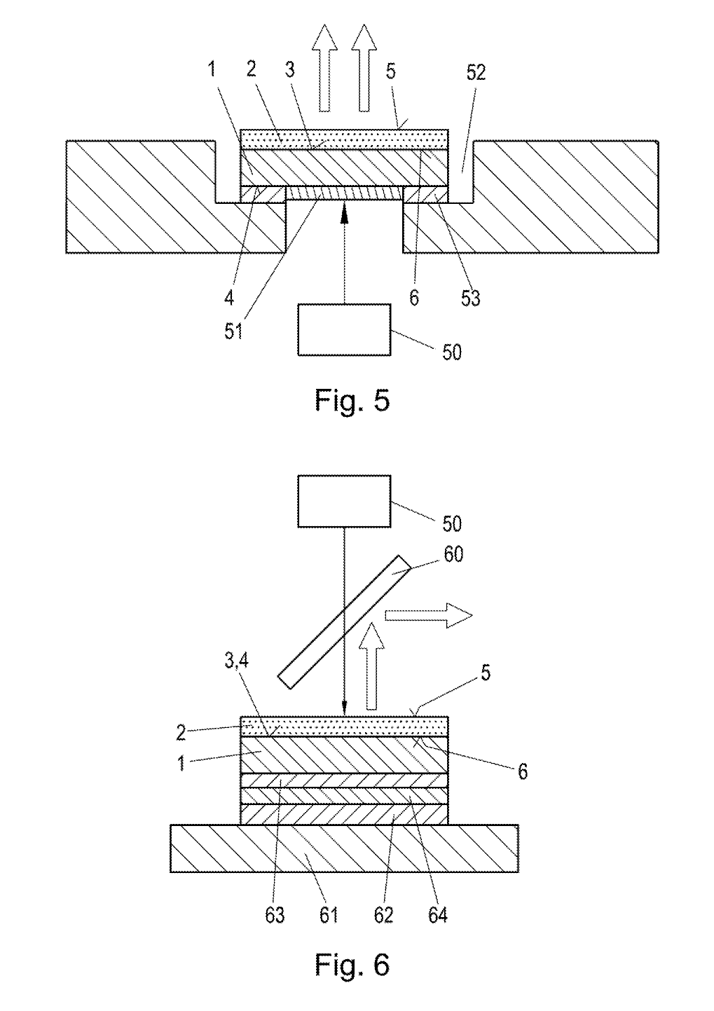

In the embodiments in accordance with FIG. 5 and FIG. 6, a laser 50, namely a laser diode, arranged at a distance from the conversion device is provided as pump radiation source (a plurality of laser diodes may also be arranged in an array). The structures in accordance with FIG. 5 and FIG. 6 then differ in detail by the type of operation for the phosphor element 1 as transmission (FIG. 5) or reflection (FIG. 6).

Accordingly, the incoming radiation surface 4 and the emission surface 3 are opposite one another in the phosphor element 1 operated in transmission in accordance with FIG. 5 (like in the section in accordance with FIG. 1); i.e., blue pump light is radiated thereon on one side and the conversion light (with optionally a component of non-converted pump light) is led away at the opposite side. A dichroic mirror 51 which transmits the pump light but reflects the conversion light is arranged at the incoming radiation surface 4; this helps increase the component of the conversion light then finally output to the front (upward in the figure). In principle, this is because the conversion light emission in the phosphor element 1 is carried out in an omnidirectional manner, but the dichroic mirror 51 finally does actually lead conversion light emitted counter to the used direction to the emission surface 3.

The entire conversion device is held in a cooling body 52. On account of the concept according to various embodiments, it may have a smaller embodiment than in a comparative case with powdery YAG:Ce and/or the output power of the laser 50, i.e. the pump radiation influx, may be increased. The conversion device may be sintered onto the cooling body 52 or connected thereto by way of a solder layer 53.

In the arrangement in accordance with FIG. 6, the phosphor element 1 is operated in a reflective manner, i.e. the incoming radiation surface 3 and the emission surface 4 coincide. Here, a dichroic mirror 60 which transmits the blue pump light but reflects the conversion light generated during full conversion and thus outcouples the latter to the side is arranged between the laser 50 and the conversion device.

The conversion device is once again assembled on a cooling body 61; to be precise, it is connected thereto (and also thermally connected) by way of a solder layer 62. A rear side of the phosphor element 1 lying opposite the combined incoming radiation/emission surface 3, 4 is provided with a metallic mirror layer 63, at which conversion light output toward the bottom (and the pump light not yet completely converted to that point) is reflected. The interaction between phosphor element 1 and scattering element 2 corresponds to the description above, to which reference is made in this respect. Furthermore, a barrier layer 64 is arranged between the mirror layer 63 and the solder layer 62, said barrier layer preventing inward diffusion of solder materials into the remaining layer structure.

In the exemplary embodiments according to FIG. 4 to FIG. 6, reference is always made to a structure in accordance with FIG. 1, i.e. a macroscopically monocrystalline phosphor element 1 including a layer-shaped scattering element 2 thereon. Equally, the structures could naturally also be realized using a conversion device in accordance with FIG. 2.

A conversion device including the above-described converting and scattering elements may optionally be embedded in a material with high reflectivity at the lateral surface thereof. Suitable to this end are both reflecting coatings (e.g. metallic mirrors, dielectric coatings) and optical materials with high volume scattering (e.g.: aluminum oxide, Teflon, pigment-filled binders). This development reduces the lateral light propagation and therefore increases the luminance and improves the light mixing.

### LIST OF REFERENCE SIGNS

Phosphor element 1
Phosphor body 1a, b, c
Scattering element 2
Emission surface 3
Incoming radiation surface 4
Emergence surface 5
Entrance surface 6
Scattering centers 7
LED 40
Substrate 40a
Epitaxial layer 40b
Emission surface 41
Cooling body 42
Laser 50
Dichroic mirror 51
Cooling body 52
Solder layer 53
Dichroic mirror 60
Cooling body 61
Solder layer 62
Metallic mirror layer 63
Barrier layer 64

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A conversion device, comprising:
a phosphor element made of a phosphor element material for converting pump radiation into conversion radiation; and
a scattering element embodied as a volume scatterer;
wherein the scattering element is arranged in direct optical contact with the phosphor element in order to be transilluminated by the conversion radiation; and
wherein the phosphor element material is present in monocrystalline form in the phosphor element over a volume of at least 1×10⁻² mm³.

2. The conversion device of claim 1,
wherein the scattering element is provided to be made of a scattering element material which has a refractive index deviating by no more than 20% from a refractive index of the phosphor element material.

3. The conversion device of claim 1,
wherein the phosphor element forms a contiguous emission surface on which the scattering element is arranged, wherein the emission surface has an area of at least 0.25 mm².

4. The conversion device of claim 3,
wherein the scattering element is fastened to the emission surface by a joining connection layer.

5. The conversion device of claim 3,
wherein the scattering element is provided such that it is made of a scattering element material which is a ceramic material, wherein the scattering element is sintered onto the phosphor element.

6. The conversion device of claim 3,
wherein the scattering element is applied to the emission surface as a coating.

7. The conversion device of claim 4, further comprising:
a plurality of phosphor elements, each phosphor element made of a phosphor element material for converting pump radiation into conversion radiation, wherein the phosphor element material is present in monocrystalline form in the phosphor element over a volume of at least 1×10⁻² mm; and
a plurality of scattering elements each scattering element embodied as a volume scatterer, wherein the scattering element is arranged in direct optical contact with a respective one of the phosphor elements in order to be transilluminated by the conversion radiation; and
wherein the phosphor elements and the scattering elements are respectively embodied as a layer in their own right and are arranged in a layer stack in such a way that they follow one another alternately in a stacking direction of the layer stack.

8. A conversion device, comprising:
a phosphor element made of a phosphor element material for converting pump radiation into conversion radiation; and
a scattering element embodied as a volume scatterer;
wherein the scattering element is arranged in direct optical contact with the phosphor element in order to be transilluminated by the conversion radiation; and
wherein the phosphor element comprises a multiplicity of partial volumes, each with a volume of at least 5×10⁻⁶ mm³, throughout which the phosphor element material, in its own right, is present in monocrystalline form in each case.

9. The conversion device of claim 8, further comprising:
a plurality of phosphor elements, each phosphor element made of a phosphor element material for converting pump radiation into conversion radiation, wherein the phosphor element comprises a multiplicity of partial volumes, each with a volume of at least 5×10⁻⁶ mm³, throughout which the phosphor element material, in its own right, is present in monocrystalline form in each case; and
a plurality of scattering elements, each scattering element embodied as a volume scatterer, wherein the scattering element is arranged in direct optical contact with a respective phosphor element in order to be transilluminated by the conversion radiation;
wherein the phosphor elements and the scattering elements are respectively embodied as a layer in their own right and are arranged in a layer stack in such a way that they follow one another alternately in a stacking direction of the layer stack.

10. The conversion device of claim 8,
wherein the partial volumes are formed by a separate phosphor body in each case,
wherein the phosphor bodies are embedded in a scattering element material which forms a matrix, said scattering element being provided such that it is made of said scattering element material.

11. The conversion device of claim 8,
wherein the phosphor element material is cerium-doped yttrium aluminum garnet.

12. The conversion device of claim 8,
wherein the scattering element is provided such that it is made of a scattering element material which is a ceramic material.

13. The conversion device of claim 12,
wherein the scattering element is provided such that it is made of a scattering element material which is aluminum oxide or magnesium oxide.

14. The conversion device of claim 8,
wherein a scattering element material, from which the scattering element is provided, and the phosphor element material directly adjoin one another.

15. The conversion device of claim 14,
wherein the scattering element is sintered onto the phosphor element.

16. The conversion device of claim 8,
the lateral surface of which, at least in portions, is embedded in a material with a high reflectivity.

17. An irradiation apparatus, comprising:
a conversion device, comprising:
a phosphor element made of a phosphor element material for converting pump radiation into conversion radiation; and
a scattering element embodied as a volume scatterer;
wherein the scattering element is arranged in direct optical contact with the phosphor element in order to be transilluminated by the conversion radiation; and
wherein the phosphor element material is present in monocrystalline form in the phosphor element over a volume of at least 1×10⁻² mm³;
and a pump radiation source for emitting the pump radiation, said components being arranged relative to one another in such a way that the phosphor element is irradiated by the pump radiation during operation.

18. The irradiation apparatus of claim 17,
wherein the pump radiation source is a light-emitting diode comprising an emission surface for emitting the pump radiation,
wherein the phosphor element is provided in direct optical contact with the emission surface.

19. The irradiation apparatus of claim 17,
wherein the pump radiation source is a laser, from which the phosphor element is arranged at such a distance that the pump radiation passes through a gas volume in an optically effective manner between the laser and the phosphor element.

20. A method for producing a conversion device,
the conversion device comprising:
a phosphor element made of a phosphor element material for converting pump radiation into conversion radiation; and
a scattering element embodied as a volume scatterer;
wherein the scattering element is arranged in direct optical contact with the phosphor element in order to be transilluminated by the conversion radiation; and
wherein the phosphor element material is present in monocrystalline form in the phosphor element over a volume of at least 1×10⁻² mm³;
the method comprising:
providing the scattering element and the phosphor element in direct optical contact with one another.

21. A method for producing a conversion device,
the conversion device comprising:
a phosphor element made of a phosphor element material for converting pump radiation into conversion radiation; and
a scattering element embodied as a volume scatterer;
wherein the scattering element is arranged in direct optical contact with the phosphor element in order to be transilluminated by the conversion radiation; and
wherein the phosphor element comprises a multiplicity of partial volumes, each with a volume of at least 5×10⁻⁶ mm³, throughout which the phosphor element material, in its own right, is present in monocrystalline form in each case;
the method comprising:
providing the scattering element and the phosphor element in direct optical contact with one another.
